(19) United States
(12) Patent Application Publication
(10) Pub. No.: US 2016/0117723 A1
(43) Pub. Date: Apr. 28, 2016

(54) CARDHOLDER OFFER TARGETING AND MERCHANT PROFILING USING PERSONAL CHARACTERISTIC DATA

(71) Applicant: MasterCard International Incorporated, Purchase, NY (US)

(72) Inventor: Justin Xavier Howe, San Francisco, CA (US)

(21) Appl. No.: 14/521,759

(22) Filed: Oct. 23, 2014

(51) Int. Cl. G06Q 30/02

(52) U.S. Cl. CPC G06Q 30/0251

(57) ABSTRACT

A method includes receiving personal characteristic data for a population of holders of payment card accounts. In addition, the method may include receiving payment card account transaction data associated with a merchant. Further, the method may include analyzing the personal characteristic data and the payment card account transaction data to generate a time-based customer population profile for the merchant. The time-based customer population profile may be used in targeted marketing operations on behalf of the merchant.

### BACKGROUND

Merchants or organizations retained by merchants often engage in targeted marketing campaigns in which messages are directed to individuals having certain types of personal characteristics. Often the personal characteristics of the individuals are determined based on surveys and/or from data obtained from commercial sources of individualized data. Some known techniques for inferring individuals' personal characteristics may involve using “cookies” stored on the individuals' computers to track the individuals' computer-based activities and/or profiling the types of content that the individuals read by using their computers.

The present inventors have now recognized additional opportunities for targeted marketing techniques based on analysis of payment card account transaction data.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a diagram that schematically illustrates a marketing technique in accordance with aspects of the present invention.

FIG. 2 is a block diagram that illustrates a computer system that may be provided in accordance with aspects of the present invention.

FIG. 3 is a flow diagram depicting a process pursuant to some embodiments.

FIG. 4 illustrates a block of data that may be received in connection with the process of FIG. 3.

FIG. 5 is a flow diagram that illustrates some details of the process of FIG. 3.

FIG. 6 is a block diagram depicting an alternative arrangement of computing resources that may perform the process of FIG. 3.

### DETAILED DESCRIPTION

In general, and for the purpose of introducing concepts of embodiments of the present invention, a data set may be received containing data indicative of transactions routed in a payment card network. The data set may be filtered to produce a narrower data set that contains only transactions for a particular merchant. Data may also be obtained that indicates personal characteristics of cardholders who participate in the payment card system. Based on the transaction data for the merchant, including the timing of the transactions and the account numbers contained in the transaction data, and also based on the personal characteristics of the corresponding cardholders, an analysis is performed to build a time-based customer population profile for the merchant. The profile may indicate the prevailing personal characteristics of the merchant's customers according to the times when the customers transact with the merchant.

With the profile, targeted marketing efforts may be undertaken. For example, the targeting of marketing messages may seek to bring in customers at times when customers with matching personal characteristics are normally present at the merchant, according to the merchant profile.

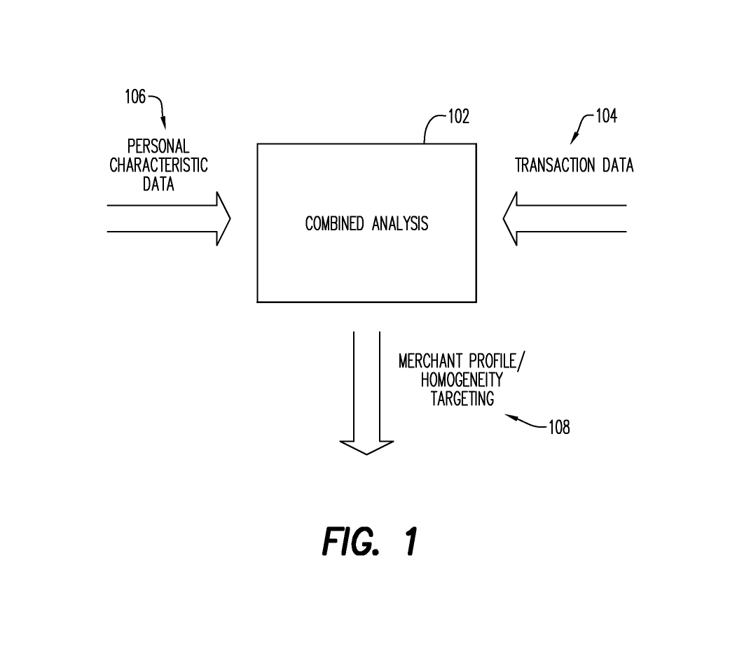

FIG. 1 is a diagram that schematically illustrates a marketing technique in accordance with aspects of the present invention. Shown in FIG. 1 is a combined analysis functional block 102. One input to the combined analysis block 102 may include transaction data (reference numeral 104) that reflects transactions routed through a payment card network. (One example of such a network is the well-known “Banknet” system operated by MasterCard International Incorporated, which is the assignee hereof) For a given transaction, the transaction data may identify the merchant involved in the transaction, the time and date of the transaction, the transaction location, and the payment card account number (also referred to as the “primary account number” or “PAN”) that identifies the payment card account used for the transaction. The transaction data may include other information as well, including the amount of the transaction, but the latter information may not be utilized in the marketing techniques described herein.

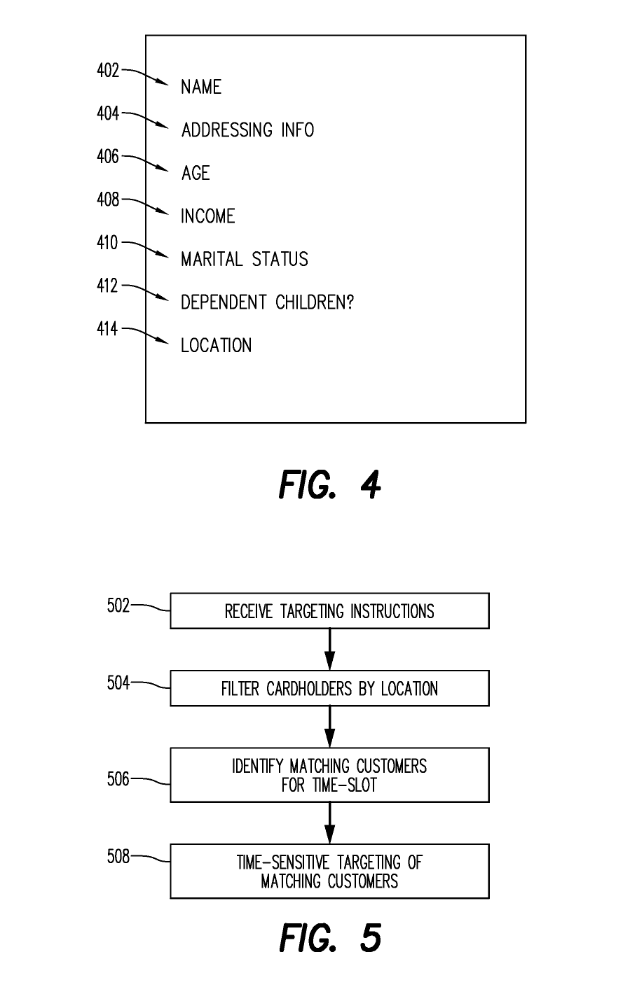

Another input to the combined analysis block 102 may include personal characteristic data (reference numeral 106) that indicates personal characteristics of cardholders who participate in the payment card system from which the transaction data was obtained. Examples of types of personal characteristics indicated by the personal characteristic data will be described below, including the below discussion of FIG. 4. The personal characteristic data may be gathered/inferred, for example, by analysis of individuals' payment card account transactions, as disclosed for example in U.S. Published Patent Application No. 2009/0192875 (which is commonly assigned herewith). In addition or alternatively, personal characteristic information may be gathered and/or inferred from so-called “probe data” (e.g., tracking of the locations of mobile communication devices and/or navigation devices), and/or from information explicitly provided by cardholders, and/or from social media accounts.

An output (indicated at 108) of the combined analysis block 102 may be a profile of the merchant that indicates what types of customers the merchant has (in terms of the customers' personal characteristics) at various times of day, and/or by day of the week and/or by the day of the year and/or on holidays and/or based on phases of the moon and/or by day of the month. A further output of the combined analysis block 102 may include targeted marketing messages to potential customers of the merchant (i.e., to cardholders), and the targeting may be such as to increase the likelihood that the recipients of the messages will visit the merchant at times when customers of similar characteristics are likely to be at the merchant.

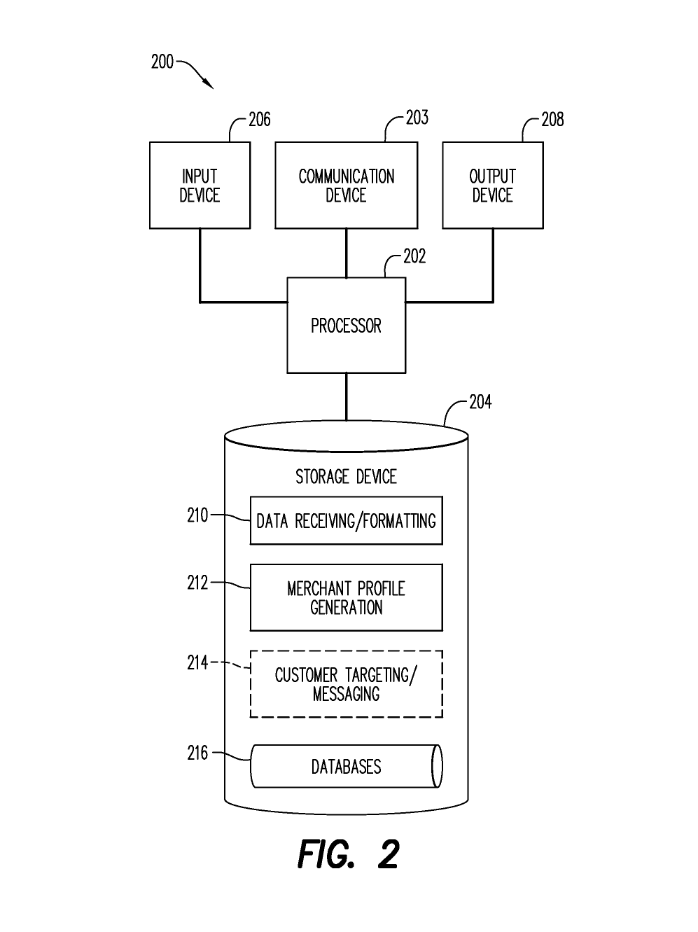

FIG. 2 is a block diagram that illustrates a computer system 200 that may be provided in accordance with aspects of the present invention. The computer system 200 may, for example, implement some or all of the functions of the combined analysis block 102 of FIG. 1.

The computer system 200 may be conventional in its hardware aspects but may be controlled by software to cause it to function as described herein. The computer system 200 may include a computer processor 202 operatively coupled to a communication device 203, a storage device 204, an input device 206 and an output device 208.

The computer processor 202 may be constituted by one or more conventional processors. Processor 202 operates to execute processor-executable steps, contained in program instructions described below, so as to control the computer system 200 to provide desired functionality.

Communication device 203 may be used to facilitate communication with, for example, other devices (such as sources of the data inputs illustrated in FIG. 1, and/or recipients of targeted messages). For example (and continuing to refer to FIG. 2), communication device 203 may comprise a number of communication ports (not separately shown), to allow the computer system 200 to communicate simultaneously with a number of other computers and other devices.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 902. The programs comprise program instructions (which may be referred to as computer readable program code means) that contain processor-executable process steps of the computer system 200, executed by the processor 202 to cause the computer system 200 to function as described herein.

The programs may include one or more conventional operating systems (not shown) that control the processor 202 so as to manage and coordinate activities and sharing of resources in the computer system 200, and to serve as a host for application programs (described below) that run on the computer system 200.

The programs stored in the storage device 204 may also include a data receiving and/or formatting application program 210 that controls the processor 202 to enable computer system 200 to receive and/or pre-process the data inputs illustrated in FIG. 1. For example, the application program 210 may remove from one or both data inputs all data that is extraneous to the desired function of generating the above-mentioned merchant profile.

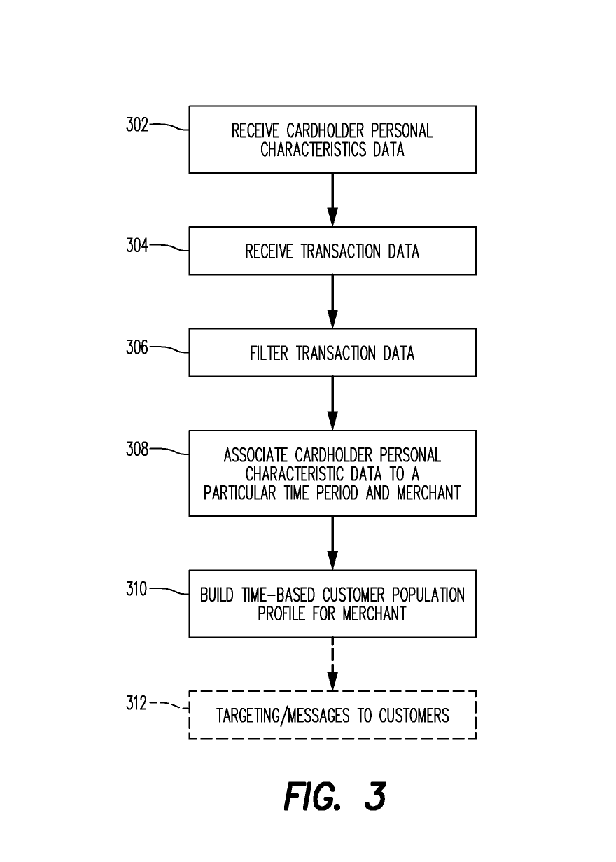

Another program that may be stored in the storage device 204 is merchant profile generation application program 212. This application program may control the processor 202 to enable the computer system 200 to generate the above-mentioned merchant profile. Details of operation of the application program 212 will be described below in conjunction with FIG. 3 and other drawing figures.

In some embodiments of the computer system 200, it may also perform targeted marketing operations using the merchant profile generated by the application program 212. Another application program 214 to perform the targeted marketing may also be stored in the storage device 204. Details of operation of the application program 214 will be described below in connection with FIG. 5.

The storage device 204 may also store, and the computer system 200 may also execute, other programs, which are not shown. For example, such programs may include a reporting application, which may respond to requests from system administrators for reports on the activities performed by the computer system 200. The other programs may also include, e.g., data communication software, database management software, device drivers, etc.

The storage device 204 may also store one or more databases 216 required for operation of the transaction analysis computer 900. Such databases may store, for example, at least on a temporary basis, the transaction data and the personal characteristic data (as illustrated in FIG. 1), and/or one or more subsets thereof, as needed for the processing by application programs 210, 212 and 214.

FIG. 3 is a flow diagram depicting a process pursuant to some embodiments. In particular, FIG. 3 shows an example process that may be performed by the computer system 200 as a consequence of operation of application programs 210, 212 and/or 214.

At 302 in FIG. 3, the computer system 200 may receive the cardholder personal characteristic data 106 (FIG. 1). FIG. 4 illustrates a block of data that may be received with respect to a typical individual cardholder in an example embodiment of the invention as part of the personal characteristic data 106. In this example, the information received for each or a typical cardholder may include the cardholder's name 402 and addressing information 404 (e.g., an email address and/or mobile telephone number for the cardholder). In addition, the information for the cardholder may include his/her age 406, annual income (or household income) 408, and his/her marital status 410. A data element 412 may also be included to indicate whether or not the cardholder has dependent children (and/or children within a certain age bracket, such as 0 to 18 years, or 0 to 6 years). In addition, the cardholder personal characteristic data may include the cardholder's geographical location (e.g., home address) 414.

Referring again to FIG. 3, at block 304 the computer system 200 may receive the transaction data 104 (FIG. 1). Continuing to refer to FIG. 3, at 306 the computer system 200 may filter the transaction data to remove therefrom all transactions that do not involve a particular merchant (i.e., the merchant for which a customer population profile is to be generated). Alternatively, in the process of FIG. 3, the transaction data received at 304 may, in effect, have been pre-filtered so as only to include transactions for a single merchant.

In other embodiments, and/or in other situations, the transaction data may be filtered to include only transactions that occurred at a particular merchant location (e.g., only at one restaurant location in a chain of restaurants). This may be desirable when the profile is to be generated for a particular store, rather than for a (multi-location) merchant as a whole.

At block 308 in FIG. 3, the computer system 200 analyzes the transaction data so as to detect cardholders who are present at a particular merchant at particular time periods, e.g., particular hours or segments of a day, and/or particular days of the week (and/or days of the year) based on payment card transactions between the cardholders and the merchants and the timing of those transactions. The timing of the customer visits to the merchant/merchant location may be determined based on the date and time information contained in the transaction data for the merchant/merchant location. As indicated at block 310, for each time period, the computer system 200 may compile statistics that indicate the personal characteristics of the customers who visit/transact with the merchant/merchant location during the time period. The statistics compiled may relate to one or more of the customers' age, income, family status (marital status and/or whether the customers have dependent children), etc. In some embodiments, the gender of the customers may also be included in the available personal characteristic data, and may be subject to the statistical compilation. In some embodiments, the compiled statistics may be averages and/or division of the customers into categories according to their personal characteristics (e.g., age brackets, income brackets).

The compiled statistics for the various time periods may be considered to be a time-based customer population profile for the merchant or merchant location in question. For example, for a particular restaurant location, the statistics may show that the typical customer at lunch time and from 5:00 p.m. to 7:00 p.m. is a parent or parents in their 20 s or 30 s with young children; and that the typical customer from 7:00 p.m. to 9:00 p.m. is a married individual in his or her 40 s or 50 s with no children. Further statistics about customer personal characteristics may be compiled for the balance of the time periods during the restaurant's operating hours. The time profile may, instead of a simple profile of the typical day's customers, be further detailed so as to relate to time periods denominated by both hour/time period plus the day of the week. In addition, or alternatively, the profile may indicate customer population characteristics on holidays and/or based on phases of the moon and/or by day of the month. In still other embodiments or situations, the time profile may be further detailed and may relate to particular calendar dates during the year. For example, in some embodiments, the profile may compile statistics for multiple time periods for each day of the calendar year.

In some embodiments, the computer system 200 may use the customer population profile for the merchant to engage in customer targeting operations, as represented by block 312 in FIG. 3. Details of the process of block 312 will be described below in connection with FIG. 5. In some embodiments, the customer targeting activities may be designed to attract customers to the merchant/merchant location at times when the customer population profile indicates that a majority or largest portion of customers present at the merchant/merchant location at those times have personal characteristics that are shared by those of the customers targeted by the marketing operations. The result of such targeting may be to increase the homogeneity of the customer population at the merchant/merchant location during at least some time periods, which may improve the customers' experience at the merchant/merchant location. For example, families with young children may be primarily attracted at certain hours, whereas at other times older couples without young children may be predominantly present.

Further, by improving the customers' experience at the merchant, the processes of the present invention may also increase the effectiveness of the merchant's marketing operations.

Referring now to FIG. 5, at 502, the operator of the computer system 100 may receive instructions from the merchant about what marketing objective or objectives the merchant has. For example, the merchant may be a restaurant and may wish to increase business during the early hours of dinner service.

At 504, the computer system 200 may filter a database of cardholders by removing cardholders who are not geographically located within a reasonable degree of proximity to the merchant's location. In some embodiments, this filtering may be based on the cardholders' home addresses. In other embodiments, the cardholders' current locations may be tracked in real time by one or more techniques, to identify those who are currently close enough to the merchant to make them worthwhile targets for time-sensitive marketing efforts.

At 506, the computer system 200 may use the customer population profile for the merchant and the cardholders' personal characteristic data (i.e., for cardholders remaining after the geographically based filtering) to identify cardholders who share personal characteristics with the personal characteristic profile for a currently relevant time period for the merchant. Continuing with the previously assumed example, if the target marketing period is early dinner hour, and the customer population profile indicates a prevalence of families with young children, the operation of block 506 may identify cardholders who are parents of young children.

In some embodiments, various analytical tools may be utilized to detect similarity between potentially targeted cardholders' personal characteristics and the customer population characteristics indicated for a given time period for a given merchant/merchant location. For example, in some embodiments, the “Force Atlas” algorithm included in the well-known Gephi network analysis software package may be employed for this purpose.

At 508 in FIG. 5, the computer system 200 may transmit marketing messages to the cardholders identified at 506 to seek to motivate the identified cardholders to visit the merchant/merchant location at the desired time period for which their personal characteristics are shared with the customer profile characteristics for the merchant at the particular time period. In some embodiments, the marketing messages may include one or more of a recommendation, an advertisement, an offer, a promotion and/or a coupon. In some embodiments, any incentive offered to the recipients of the targeted messages may be time-sensitive.

In some embodiments there may be a forward offset between the timing of the targeted message and the occurrence of the relevant time period represented in the merchant profile. For example, in the case of a restaurant, the timing of the marketing messages may be offset two hours ahead of the detected time of the payment card transactions for the type of customer in question. This may reflect the fact that typically in a restaurant visit, the guest check is presented and the payment card transaction occurs an hour or more after the customer arrives at the restaurant (for conventional restaurants rather than fast food restaurants). The balance of the two- hour offset period may account for the targeted cardholders' travel time to the merchant, time for decision-making, etc.

In other embodiments, the marketing message may be sent well in advance, but with a time-sensitive incentive to attract the targeted cardholder at the desired time period. (E.g., the time-sensitive incentive may be a coupon that is valid for use only from 5:00 p.m. to 7:00 p.m.)

In some embodiments, the marketing message may be sent to the cardholder via mobile telephone text message and/or by e-mail. In some embodiments, the marketing message may be sent by postal mail.

In embodiments described above, targeted marketing may be employed to promote homogeneity of the customer population at certain times. However, in other embodiments, there may be other goals in terms of promoting a particular mix of customers. For example, a pub may commission marketing efforts aimed at achieving as even as possible a balance between the two genders, while also promoting homogeneity in terms of age for a given time period.

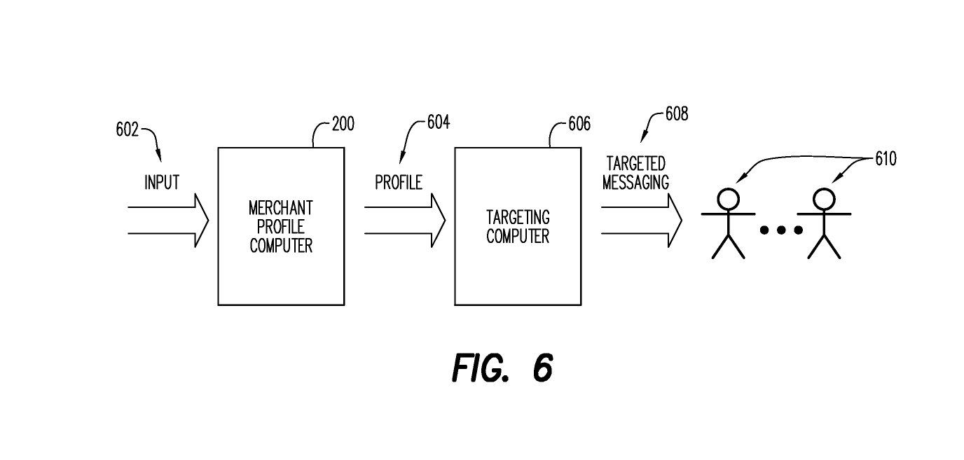

In embodiments discussed above, a single computer system 200 was described as both generating a merchant profile and utilizing the merchant profile to engage in targeted marketing operations. In other embodiments, such as that illustrated in FIG. 6, these two tasks may be divided between two different computer systems.

For example, in FIG. 6, the computer system 200 is shown receiving data input at 602 and outputting a merchant profile 604 to another computer system 606. The computer system 606 may have the same sort of hardware architecture and components as are illustrated in FIG. 2. The computer system 606 may be programmed to perform targeted marketing using the merchant profile 604. This may occur, for example, in the manner described above in connection with FIG. 5. The computer system 606 may output targeted messages 608 directed to cardholders 610.

In some embodiments, personal characteristics other than those mentioned above may be employed in addition to or instead of those mentioned above, in connection with the merchant profiling and/or targeted marketing operations described herein.

In addition to aiding in marketing efforts to promote retail shopping and/or visits to restaurants, the profiling and targeted marketing described herein may also be employed in connection with promoting concerts, plays and other events. In such activities, cardholders' personal characteristics may further be used to seat similar individuals together at the events.

Other applications of the teachings of the present invention may include marketing of hotel, vacation, resort or cruise reservations, health club appointments, etc.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, in a computer, personal characteristic data for a population of holders of payment card accounts;
receiving, in the computer, payment card account transaction data associated with a merchant; and
analyzing, by the computer, said personal characteristic data and said payment card account transaction data to generate a time-based customer population profile for said merchant.

2. The method of claim 1, wherein said time-based customer population profile indicates typical personal characteristics of customers of said merchant by time of day and/or by day of week and/or by day of year and/or on holidays and/or based on phases of the moon and/or by day of month.

3. The method of claim 2, wherein said analyzing step includes identifying ones of said population of holders of payment card accounts as customers who entered into payment card account transactions with said merchant.

4. The method of claim 2, further comprising:
transmitting messages to a plurality of said population of holders of payment card accounts, said messages for motivating recipients of said messages to visit said merchant at times when said time-based customer population profile indicates that a majority or largest portion of other customers of said merchant at those times share personal characteristics with said recipients of said messages.

5. The method of claim 4, wherein each of said messages contains at least one of: (a) an advertisement; (b) a coupon: (c) a promotion; and (d) an offer.

6. The method of claim 5, wherein said messages are transmitted at said times when said time-based customer population profile indicates that a majority or largest portion of other customers of said merchant at those times share personal characteristics with said recipients of said messages.

7. The method of claim 6, wherein said recipients of said messages are selected so as to be located within a predetermined distance from the merchant.

8. The method of claim 1, wherein said personal characteristic data indicates personal characteristics of said population of holders of payment card accounts, said personal characteristics including one or more of: age, income, marital status, and whether said holders of payment card accounts have dependent children.

9. A non-transitory medium having program instructions stored thereon, the medium comprising:
instructions to receive personal characteristic data for a population of holders of payment card accounts;
instructions to receive payment card account transaction data associated with a merchant; and
instructions to analyze said personal characteristic data and said payment card account transaction data to generate a time-based customer population profile for said merchant.

10. The medium of claim 9, wherein said time-based customer population profile indicates typical personal characteristics of customers of said merchant by time of day and/or by day of week and/or by day of year and/or on holidays and/or based on phases of the moon and/or by day of the month.

11. The medium of claim 10, wherein said analyzing includes identifying ones of said population of holders of payment card accounts as customers who entered into payment card account transactions with said merchant.

12. The medium of claim 10, further comprising:
instructions to transmit messages to a plurality of said population of holders of payment card accounts, said messages for motivating recipients of said messages to visit said merchant at times when said time-based customer population profile indicates that a majority or largest portion of other customers of said merchant at those times share personal characteristics with said recipients of said messages.

13. The medium of claim 12, wherein each of said messages contains at least one of: (a) an advertisement; (b) a coupon: (c) a promotion; and (d) an offer.

14. The medium of claim 13, wherein said messages are transmitted at said times when said time-based customer population profile indicates that a majority or largest portion of other customers of said merchant at those times share personal characteristics with said recipients of said messages.

15. The medium of claim 14, wherein said recipients of said messages are selected so as to be located within a predetermined distance from the merchant.

16. The medium of claim 9, wherein said personal characteristic data indicates personal characteristics of said population of holders of payment card accounts, said personal characteristics including one or more of: age, income, marital status, and whether said holders of payment card accounts have dependent children.

17. An apparatus comprising:
a processor; and
a memory in communication with said processor and storing program instructions, said processor operative with the program instructions to perform functions as follows:
receiving personal characteristic data for a population of holders of payment card accounts;
receiving payment card account transaction data associated with a merchant; and
analyzing said personal characteristic data and said payment card account transaction data to generate a time-based customer population profile for said merchant.

18. The apparatus of claim 17, wherein said time-based customer population profile indicates typical personal characteristics of customers of said merchant by time of day and/or by day of week and/or by day of year and/or on holidays and/or based on phases of the moon and/or by day of month.

19. The apparatus of claim 18, wherein said analyzing step includes identifying ones of said population of holders of payment card accounts as customers who entered into payment card account transactions with said merchant.

20. The apparatus of claim 18, wherein the processor is further operative with the program instructions to transmit messages to a plurality of said population of holders of payment card accounts, said messages for motivating recipients of said messages to visit said merchant at times when said time-based customer population profile indicates that a majority or largest portion of other customers of said merchant at those times share personal characteristics with said recipients of said messages.
